(19) United States
(12) Patent Application Publication
(10) Pub. No.: US 2009/0180614 A1
(43) Pub. Date: Jul. 16, 2009

(54) CONTENT PROTECTION OF INTERNET PROTOCOL (IP)-BASED TELEVISION AND VIDEO CONTENT DELIVERED OVER AN IP MULTIMEDIA SUBSYSTEM (IMS)-BASED NETWORK

(75) Inventors: Priya Rajagopal, Shrewsbury, MA (US); Marie Jose Montpetit, Jamaica Plain, MA (US); Petr Peterka, San Diego, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/972,451

(22) Filed: Jan. 10, 2008

(51) Int. Cl. H04L 9/08; H04N 7/167

(52) U.S. Cl. 380/228; 380/278

(57) ABSTRACT

Content delivered to client device over an Internet Protocol Multimedia Subsystem (IMS)-based network is protected through a digital rights management (DRM) scheme that leverages IMS service and access infrastructure, such as the IMS core. After authentication and selection of content to be played for the user, the network identifies a key management system having keys for decrypting the selected content. A bootstrapping service function participates in an application-level authentication of the client device to establish a secure communication channel between the key management system and the client device. The key management system responds to a content key request received from the client device by providing a content key via the secure communication channel. The network can then stream content to the client device, which decrypts it using the content key.

### BACKGROUND OF THE INVENTION

1. Field of the Invention

The invention relates to Digital Rights Management (DRM) in Internet Protocol Multimedia Subsystem (IMS)-based systems.

2. Description of the Related Art

So-called “broadband” digital communication services allow users (i.e., subscribers to the services) to receive multimedia (i.e., video, audio, etc.) content, such as movies and music, on their computers, set-top boxes, wireless handsets, residential gateways and similar user devices. A digital rights management (DRM) scheme is typically employed to restrict access to the content to authorized subscribers. DRM schemes typically include encrypting the content to be transferred and providing the user devices with one or more decryption keys for decrypting the transferred content. Conventional DRM systems and formats include: Microsoft Corporation's Windows Media DRM, which is primarily used on computers; Motorola Inc.'s Internet Protocol (IP) Rights Management (IPRM), which was developed for the cable television industry and IP-based television services (IPTV); and several schemes promoted by the Open Mobile Alliance (OMA).

The IP Multimedia Subsystem (IMS) is an architectural framework for delivering IP multimedia to a variety of user devices connecting via different types of acccess networks. It was originally developed by the wireless standards body Third-Generation Partnership Project (3GPP), and is part of the vision for “next-generation networks” (NGN), i.e., networks that go beyond those descended from the original mobile telecommunications standards by transporting all information and content using IP. To ease integration with the Internet, IMS primarily uses Internet protocols such as the Session Initiation Protocol (SIP). IMS-based networks have been implemented for telephone communication (referred to as “voice over IP” or VoIP) and delivering video and music content.

The delivery of television programming via an IP-based system is generally referred to as IP Television (IPTV). IPTV can take the form of a real-time streaming service reminiscent of traditional broadcast television, a “video on-demand” (VoD) service in which a service provider transmits the IPTV content in response to specific subscriber requests, or other kinds of interactive television services. In any event, it is desirable for IPTV services to include suitable DRM and conditional access schemes so that access is restricted to authorized IPTV subscribers.

### BRIEF DESCRIPTION OF THE DRAWINGS

FIG. 1 is a block diagram of a DRM system in an IMS-based network in which IPTV is delivered to subscribers, in accordance with an exemplary embodiment of the invention.

FIG. 2 is a block diagram of a portion of the system of FIG. 1.

FIG. 3 is a communication sequence diagram illustrating a sequence of messages communicated in accordance with the exemplary embodiment to protect the delivered content.

FIG. 4 is a flow diagram further illustrating the exemplary method.

### DETAILED DESCRIPTION

In the following description, like reference numerals indicate like components to enhance the understanding of the systems, devices and methods for providing content interoperability between different digital rights management schemes through the description of the drawings. Also, although specific features, configurations and arrangements are discussed herein below, it should be understood that such specificity is for illustrative purposes only. A person skilled in the relevant art will recognize that other steps, configurations and arrangements are useful without departing from the spirit and scope of the invention.

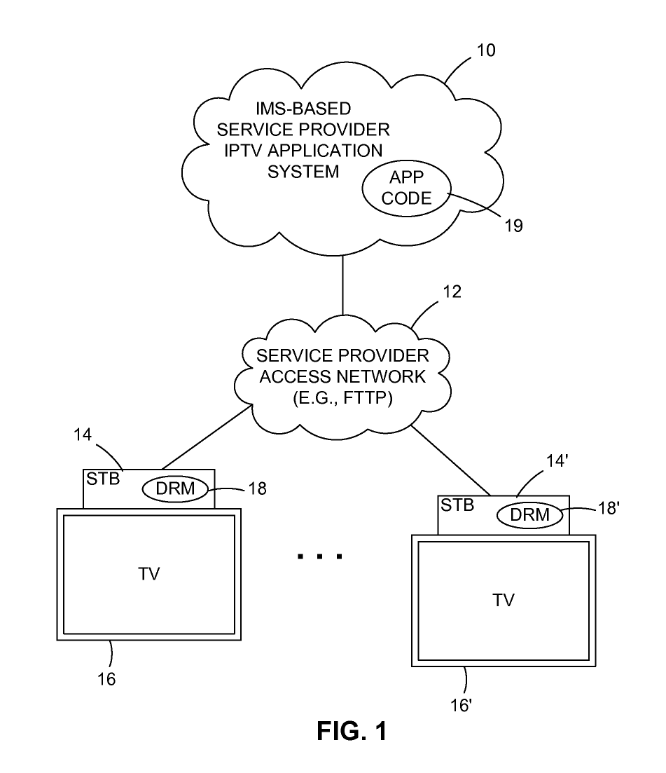

As illustrated in FIG. 1, an exemplary system through which a service provider can provide Internet Protocol Television (IPTV) content to subscribers or users involves an IP Multimedia Subsystem (IMS)-based IPTV application system 10, an access network 12, and a number of client devices 14, 14′, etc. of the type commonly referred to as a “set-top box” (STB). Each client device 14, 14′, etc. communicates with an associated television set 16, 16′, etc. in a conventional manner. Each client device 14, 14′, etc. is programmed or otherwise configured to include a digital rights management (DRM) agent 18, 18′, etc., which causes it to interact with system 10 (via access network 12) to effect DRM functions as described below. IPTV application system 10 is likewise programmed or otherwise configured to include software application code 19 that causes its processors and associated devices to effect the DRM and other functions described below. Each client device 14, 14′, etc. also includes other elements (not shown for purposes of clarity) of the types known to be includable in such a device, such as a processor system programmed or configured with an IPTV client application, media manager, streaming media player, etc.

It should be noted that although the present invention relates to IPTV delivery, the same service provider can deliver additional services, such as voice-over-IP telephony, Internet access, etc., over the same IMS-based network. (Providing telephone, television, and Internet access as a bundle of services from the same provider over the same network is sometimes referred to as “triple-play” service.) Also, although in the embodiment described herein the IPTV content is delivered on demand, i.e., in response to specific user requests such as a request to view a selected movie, in other embodiments of the invention the IPTV content can be selected by the provider and delivered in a continuously streamed manner reminiscent of a traditional television channel.

Although in the exemplary embodiment of the invention the client devices 14, 14′, etc. are STBs, and access network 12 is accordingly of a type, such as a fiber-to-the-premises (FTTP) optical network, that is well suited for delivering IPTV content to a residence or other subscriber premises, in other embodiments the client devices can be wireless handsets, residential gateways, personal computers, or any other suitable type of device capable of receiving IPTV content from a service provider network. In such other embodiments, the access network would be of a correspondingly suitable type, such as a wireless network in embodiments in which the client devices are wireless handsets.

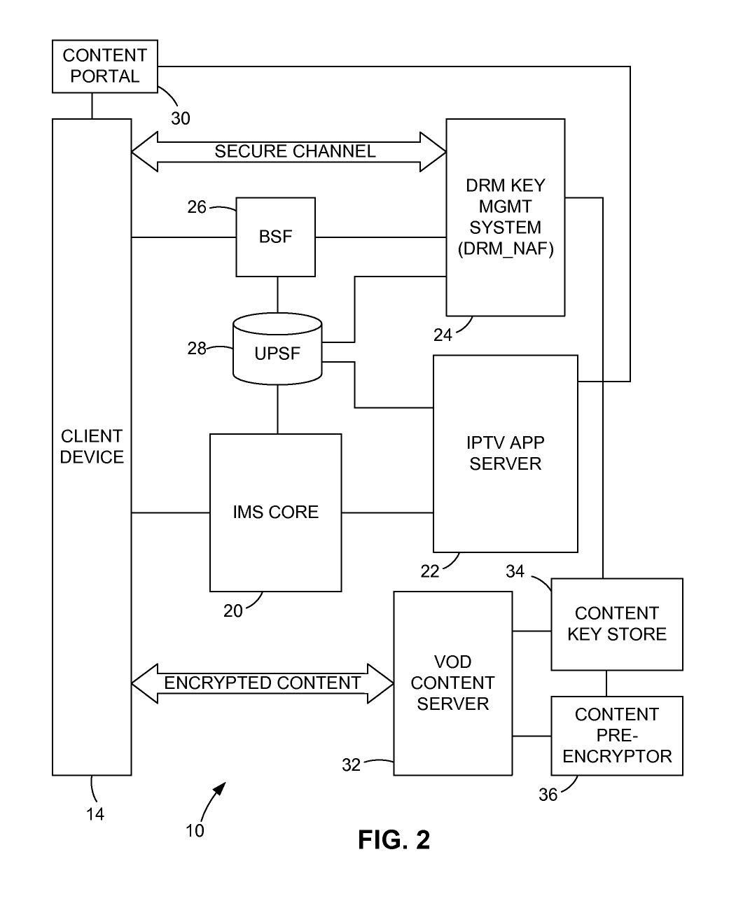

In FIG. 2, client device 14 is shown in communication with IMS-based IPTV application system 10 (with access network 12 not shown for purposes of clarity, and communication connections between elements shown in a conceptual manner for purposes of illustration). System 10 includes an IMS core 20, an IPTV application server 22, a DRM key management system (KMS) 24 (also referred to as a DRM network application function (DRM NAF or DRM NaF) 24), a bootstrapping service function (BSF) 26, a user profile service function (UPSF) 28, and a content portal 30. Also included are a video-on-demand (VOD) content server 32, a key store 34 for storing encryption and decryption keys to the content stored in content server 32, and a pre-encryptor 36 for encrypting the content with such keys prior to storing it in content server 32. Note that some of these elements can be essentially conventional, as their functions are well known in the art to which the invention relates. For example, BSF 26 can be that which is described by the well-known Generic Bootstrapping Architecture (GBA) promulgated by the Third-Generation Partnership Project (3GPP). Similarly, except as described below, IMS core 20 and IPTV application server 22 are Session Initiation Protocol (SIP)-based servers that can have essentially conventional structures and functions. IPTV application server 22 is a SIP application server that has been enhanced to provide IPTV service control functionality that includes authorizing incoming IPTV service requests, redirecting service requests to the right content servers, etc. Accordingly, except as they relate specifically to the present invention, the structures and functions of the elements listed above are not described herein in further detail for purposes of clarity. In this regard, generally speaking, as VOD delivery of content, the storage and use of keys, and DRM encryption and decryption of such content using such keys are well understood in the art, details of these aspects of the invention are not described herein for purposes of clarity. Although, FIG. 2 describes a VOD service, this invention is suitable for other multimedia content delivery methods including content download as well as live TV (also known as linear TV or multicast/broadcast TV).

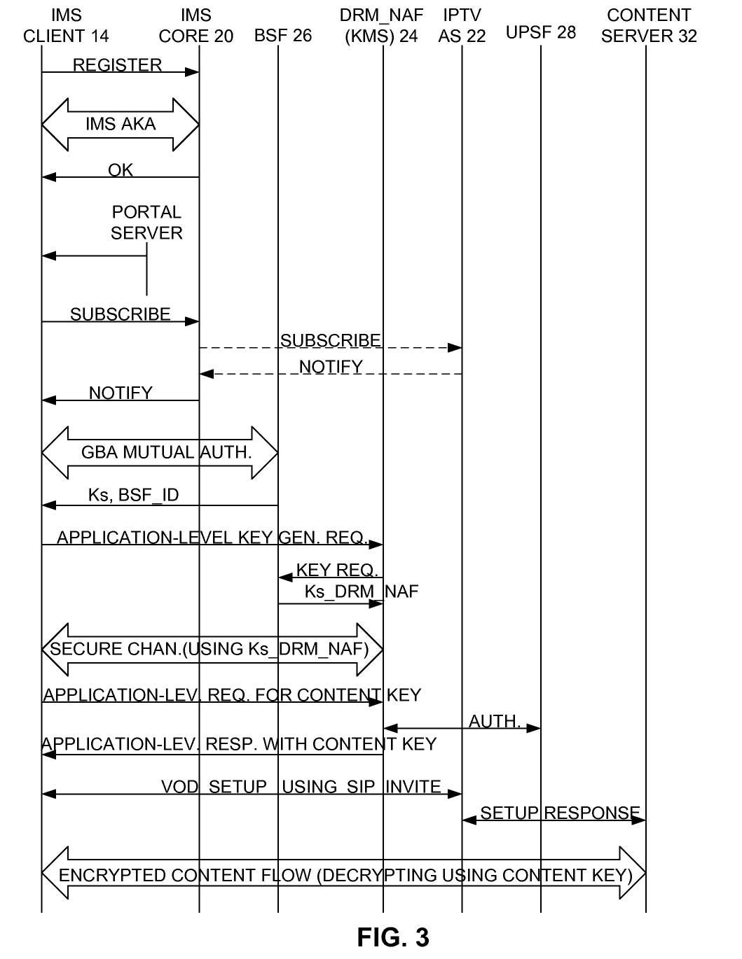

As illustrated in FIG. 3, and with continued reference to FIG. 2, a sequence of messages is communicated when IPTV content is to be delivered. First, or as a preliminary step, client device 14 registers and authenticates with IMS core 20 using the conventional IMS authentication and key agreement (AKA) method defined by the Internet Engineering Task Force (IETF) and with which persons skilled in the art are familiar. This authentication establishes an IMS AKA security association between client device 14 and the IMS-based system 10. As a result, SIP signaling can be performed in a secure manner.

It should be noted that one aspect of the invention involves the use of two levels of authentication. The above-described authentication is a service-level authentication. The other authentication, described below, is an application-level authentication.

Following service-level authentication, a user can use client device 14 to browse content portal 30 for content of interest. As known in the art, such a content portal 30 can provide a list of items available for viewing, such as movies. (For example, client device 14 can cause the list to be displayed on television set 16.) The user can use client device 14 to select content in the conventional manner. In response to the selection, content portal 30 returns to client device 14 a content identifier that identifies the selected content item. In some embodiments of the invention, it can also return a session rights object (SRO) encapsulating DRM rules associated with the selected content. In such an embodiment, the SRO is digitally signed with a KMS (NaF) key to ensure that only the intended DRM NaF 24 (and not other such DRM NaFs that may exist) can extract the DRM rules. Content portal 30 can obtain the address, i.e., the identity, of DRM NaF 24 from IPTV application server 22 so that it can sign the SRO with the corresponding key. The details of this mechanism are described in U.S. Pat. No. 7,243,366 and U.S Patent Application Publication No. 2003/0149880, assigned to the assignee of the present invention and the specifications of which are incorporated herein by this reference in their entireties. Alternatively, in other embodiments, all such DRM NaFs can be associated with the same key as each other, i.e., they can share a key that is used to sign the SRO.

In other embodiments, such as those in which the user does not select content in a VOD manner but rather receives content selected by the provider in a broadcast-like manner by providing an electronic program guide (EPG) on the portal, content portal 30 may not provide an SRO. In such instances, DRM NaF 24 can either apply the same DRM rules to all content (e.g. an entire channel) or, alternatively, access a database (not shown) of DRM rules for each available item of content (e.g. a specific event on a channel).

In the illustrated embodiment, in which client device 14 does not receive the address of DRM NaF 24 from content portal 30, client device 14 can send a SIP SUBSCRIBE message (with “DRM” as its event type, and providing the content identifier) to IPTV application server 22 via IMS core 20. IPTV application server 22 first verifies that the request is coming from an authenticated client, and then returns the address of DRM NaF 24 in a SIP NOTIFY message.

Client device 14 then establishes a secure channel with DRM NaF 24 so that its DRM agent (18, FIG. 1) can securely receive the keys for decrypting the content. To do this, client device 14 authenticates itself to BSF 26 using the well-known GBA method that such BSFs conventionally use. The result of the authentication process is a security association between the DRM agent of client device 14 and BSF 26. BSF 26 generates a session key Ks and a unique identifier BSF_ID (to be associated with the client) for this purpose.

Client device 14, through its DRM agent, then sends a request to DRM NaF 24 for the content key or keys it needs to decrypt the selected content. DRM NaF 24 responds by sending (not shown) a security bootstrapping initiation request to the DRM agent. In response, the DRM agent derives a DRM-NaF-specific (or application-specific) session key Ks_{_{—}}_{DRM}_{_{—}}_{NaF} from the general session key Ks and sends (not shown) the BSF_ID to DRM NaF 24. DRM NaF 24 then requests session keys from the BSF 26 corresponding to the BSF_ID over the secure channel. BSF 24 responds by deriving the DRM-NaF-specific session key Ks_{_{—}}_{DRM}_{_{—}}_{NaF} from the general session key Ks and sending it back to DRM NaF 24. DRM NaF24 and the DRM agent of client device 14 then use the derived application-specific key Ks_{_{—}}_{DRM NaF} as the basis for a secure communication channel between them. (Note that this step does not have to be repeated for each content request.)

Once the secure channel has been established, client device 14 sends DRM NaF 24 an application-level request over the secure channel for the content key, i.e., the key its DRM agent needs to decrypt the IPTV content that it is to receive. The request for the content key includes the content identifier and user or device identifier.

In response to the request for the content key, DRM NaF 24 performs a user authorization method to verify user entitlements and credentials (e.g. by checking the UPSF). Such entitlements can specify, for example, the types of content that the user is authorized to access. DRM NaF 24 also verifies the SRO that has the content access rules against the user entitlements.

If user authorization/entitlements and SRO verification indicate that the user is entitled to receive the selected content, DRM NaF 24 responds by sending the content key as well as applicable DRM rules to client device 14 over the secure channel. If the requisite content key is not cached in DRM NaF 24, it can first retrieve the content key from key store 34.

Once client device 14 obtains the content key, it initiates a SIP-based VOD session with IPTV application server 22 by sending a SIP INVITE. The session can conform to any suitable protocol, such as the well known Real Time Streaming Protocol (RTSP). IPTV application server 22 can accordingly initiate transmission of a content data stream by sending an RTSP Play command to content server 32. In response, content server 32 transmits or streams the (encrypted) content to client device 14.

Client device 14 includes a streaming media player (not shown) that causes the DRM agent to use the content key to decrypt the streamed content as it is received. As client device 14 is a set-top box in the exemplary embodiment, it sends the decrypted content stream to the television set 16 to which it is connected for viewing by the user. Note that this stream may also be protected with a standard link protection mechanism such as DTCP or HDCP

It should be noted that the exemplary method described above with regard to FIGS. 2 and 3 is effected through the operation of programmed processors or otherwise-configured logic in IMS core 20, IPTV application server 22, DRM NaF 24, BSF 26, UPSF 28, content portal 30, content server 32, etc. For example, each such element can have a memory in which (computer-readable) instructions are stored for execution by a processor. The memory, which can be integrated with the processor or on a separate chip, can include random access memory, read-only memory, programmed logic devices, or any other suitable type of memory in which it is known to store instructions for execution by a processor. Such instructions are collectively represented in FIG. 1 as application code 19 and DRM agent 18. The instructions can also be stored on one or more fixed or removable disks. Accordingly, it should be recognized that such memories or other computer-readable media, together with the instructions stored on such media, constitute a so-called “computer program product.” The DRM functions on the client and server side may also be coupled with software and/or hardware security functions in the form of secure memory, secure processor, smartcard, hardware security dongle, etc.

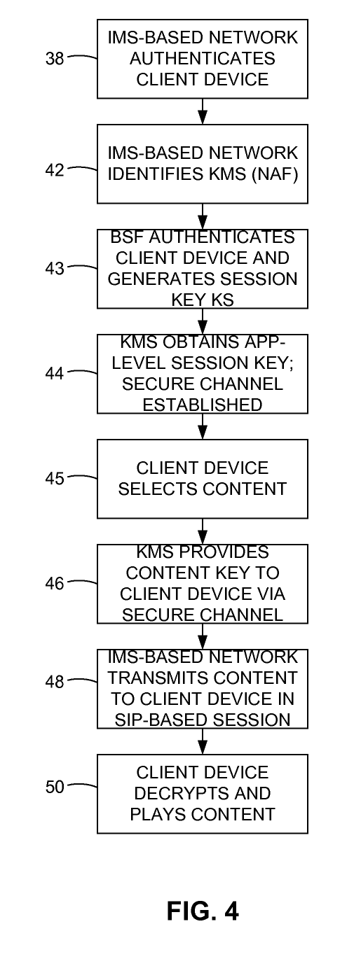

As illustrated in FIG. 4, the exemplary method for protecting content delivered to client device over an Internet Protocol Multimedia Subsystem (IMS)-based network can be further described as follows. As indicated by step 38, the network authenticates the client device as a preliminary or initial step. A bootstrapping service function (BSF) participates in an application-level authentication of (the already network-authenticated) client device and generates a session key Ks, as indicated by step 43. The key management system then communicates with the BSF to get the application-level session key Ks_{_{—}}_{DRM NaF} derived from Ks, to establish a secure communication channel between the key management system and the client device, as indicated by step 44. As indicated by step 45, the client device (or, in other embodiments, the service provider) selects content for viewing. In response to such a content selection, the network identifies a key management system having keys for decrypting the selected content, as indicated by step 42. At step 46, the key management system responds to a content key request received from client device 14 by providing a content key to the client device via the secure communication channel. As indicated by step 48, the network can then stream content to the client device. The client device can decrypt the received content using the content key, as indicated by step 50. Note that the establishment of the secure channel is independent of the content request. The secure channel can be reused for multiple pieces of content so long as the content keys are provided by the same KMS.

It will be apparent to those skilled in the art that various changes and substitutions can be made to the systems, devices and methods described herein without departing from the spirit and scope of the invention as defined by the appended claims and their full scope of equivalents.

What is claimed is:

1. A method for protecting content delivered to a client device over an Internet Protocol Multimedia Subsystem (IMS)-based network, comprising:
the IMS-based network authenticating the client device;
in response to a content selection, the IMS-based network identifying a key management system (KMS) having keys for decrypting selected content;
a bootstrapping service function (BSF) authenticating the network-authenticated client device to establish a secure communication channel between the KMS and the client device;
in response to a content key request received from the client device by the KMS, the KMS providing a content key to the client device via the secure communication channel; and
the IMS-based network providing the client device with content decryptable by the client device using the content key.

2. The method claimed in claim 1, wherein the content is Internet Protocol television.

3. The method claimed in claim 2, wherein the IMS-based network receives a video on-demand content selection from the client device.

4. The method claimed in claim 1, further comprising:
a content portal providing digital rights management (DRM) rule information for the requested content to the client device;
wherein the step of the IMS-based network identifying a key management system (KMS) having keys for decrypting selected content comprises the content portal providing a KMS address to the client device.

5. The method claimed in claim 1, wherein the step of the IMS-based network identifying a key management system (KMS) having keys for decrypting selected content comprises:
receiving a Session Initiation Protocol (SIP)-based message from the client device via an IMS core; and
in response to the SIP-based message, providing a KMS address to the client device via the IMS core.

6. The method claimed in claim 1, wherein the step of the KMS providing a content key to the client device via the secure communication channel comprises:
obtaining client device entitlement information from a user profile database; and
providing a content key to the client device if the device entitlement information indicates the client device is entitled to receive the content.

7. An Internet Protocol Multimedia Subsystem (IMS)-based network system, comprising:
an application server for initiating transmission to a SIP-enabled client device of content decryptable by the client device using a content key;
an IMS core for performing service-level authentication of the client device and passing SIP messages to and from the client device;
a key management server (KMS); and
a bootstrapping service function (BSF) for participating in application-level authentication with the client device to establish a secure communication channel between the KMS and the client device, wherein in response to a content key request received from the client device by the KMS, the KMS provides the content key to the client device via the secure communication channel.

8. The system claimed in claim 7, wherein the content is Internet Protocol television.

9. The system claimed in claim 8, wherein the IMS-based network receives a video on-demand content selection from the client device.

10. The system claimed in claim 7, further comprising a content portal for providing a KMS and digital rights management (DRM) rule information for the requested content to the client device.

11. The system claimed in claim 7, wherein the application server receives a Session Initiation Protocol (SIP)-based message from the client device via the IMS core and in response provides a KMS address to the client device via the IMS core.

12. The system claimed in claim 7, wherein the KMS obtains client device entitlement information from a user profile database and provides a content key to the client device if the device entitlement information indicates the client device is entitled to receive the content.

13. The system claimed in claim 7, further comprising a content server, wherein the application server sends the content server a content request.

14. The system claimed in claim 11, further comprising a key store for storing content keys for decrypting content stored in the content server, wherein the KMS obtains the content key from the key store.

15. A computer program product comprising computer-readable instructions stored on one or more computer-readable media for, when executed by one or more processor systems, effecting a method for protecting content delivered to a client device over an Internet Protocol Multimedia Subsystem (IMS)-based network, the instructions comprising:
instructions for authenticating the client device with the IMS-based network;
instructions for responding to a content selection by identifying a key management system (KMS) having keys for decrypting selected content;
instructions for causing a bootstrapping service function (BSF) to authenticate the network-authenticated client device to establish a secure communication channel between the KMS and the client device;
instructions for responding to a content key request received from the client device by the KMS by providing a content key to the client device via the secure communication channel; and
instructions for causing the IMS-based network to provide the client device with content decryptable by the client device using the content key.
